(19) United States
(12) Patent Application Publication
(10) Pub. No.: US 2014/0062223 A1
(43) Pub. Date: Mar. 6, 2014

(54) LINEAR GENERATOR AND METHOD FOR GENERATING POWER USING THE SAME

(71) Applicant: Industry-Academic Cooperation Foundation, Yonsei University, (US)

(72) Inventors: Jin Bae PARK, Gyeonggi-do (KR); Jae Man KIM, Seoul (KR); Min Kook SONG, Seoul (KR); Seung Kwan SONG, Seoul (KR); Jung Yoon KIM, Seoul (KR); Jae seung KIM, Gyeonggi-do (KR)

(73) Assignee: Industry-Academic Cooperation Foundation, Yonsei University, Seoul (KR)

(21) Appl. No.: 13/853,444

(22) Filed: Mar. 29, 2013

(30) Foreign Application Priority Data
Sep. 3, 2012 (KR) 1020120097243

(51) Int. Cl. H02K 1/17; H02K 35/00

(52) U.S. Cl. CPC H02K 1/17; H02K 35/00
USPC 310/12.12

(57) ABSTRACT

A linear generator and a method for generating power using the same are provided. The linear generator includes a magnet module including magnets located between a plurality of flux concentration blocks, the magnets located on both sides of each of the flux concentration blocks being arranged such that the magnets having the same pole face each other, and a magnetic flux generated from the magnets is induced into both ends of each of the flux concentration blocks; and core modules including coils and located on both sides of the magnet module to generate induced electromotive forces in the coils by the magnetic flux as the core modules move

### CROSS-REFERENCE TO RELATED APPLICATION

This application claims priority from Korean Patent Application No. 10-2012-0097243 filed on Sep. 3, 2012 in the Korean Intellectual Property Office, and all the benefits accruing therefrom under 35 U.S.C. 119, the contents of which in its entirety are herein incorporated by reference.

### BACKGROUND

1. Technical Field

The present inventive concept relates to a linear generator and a method for generating power using the same, and more particularly to a linear generator using a flux concentration method capable of efficiently configuring a space of magnets, and a method for generating power using the same.

2. Description of the Related Art

Wave energy is one type of ocean energy, which means vibration energy of seawater by wind. The waves have energy of reciprocating motion of seawater moving vertically or horizontally unlike the tide. An apparatus that converts the kinetic energy into useable energy is generally a wave energy converter.

The wave energy converter largely consists of two parts, i.e., a mechanical part which converts the kinetic energy of the vibrating waves into mechanical energy, and a generator which converts the mechanical energy into electrical energy. The mechanical part is generally configured in the form of a buoy, and a resonance frequency corresponding to the motion of the waves is determined according to its shape, mass and the like. The buoy performs vibratory motion according to the motion of the waves, and the vibration energy is converted into electrical energy through the generator.

In order to convert the kinetic energy of vibration of the bouy into electrical energy, there are a method of producing electricity through a rotary generator after converting the vibratory motion into rotational motion, and a method of using a linear generator capable of achieving power generation using the vibration. In the former case, there is need for a separate mechanical device for converting vibratory motion into rotational motion. To this end, a flywheel, fluid pump, or the like may be used, but in this case, there are disadvantages such as mechanical energy loss and a weak point occurring in the mechanical structure. Thus, in order to simplify the structure while preventing the mechanical energy loss, it is necessary to develop an energy converter for directly converting the reciprocating motion, and the linear generator has been attracting attention.

The linear generator is less competitive than the rotary generator due to disadvantages such as high manufacturing costs and low efficiency for the price as compared to the rotary generator. However, the development of the wave energy that is one of new and renewable energy sources comes into the spotlight, and has attracted much attention.

The linear generator is largely divided into a stator and a rotor. Generally, a coil is wound on a core of the stator (the core may be omitted), and magnets are arranged in the rotor. The rotor performs reciprocating motion with respect to the stator (or the stator may perform reciprocating motion with respect to the rotor), thereby producing electricity through a change of the magnetic flux density on the vertical surface of the coils. In the linear generator, since the speed of the rotor is extremely slow compared to a rotary generator, it is necessary to attenuate a cogging force. The cogging force is a magnetic force occurring between the core magnetized by magnets and the magnets, which is in the form of an attractive force to attract each other. In the rotor, since N poles and S poles of the magnets are arranged periodically, the cogging force also changes periodically. The rotor can move only when a mechanical external force which can overcome the cogging force is applied, or the inertia of the rotor itself is equal to or greater than the cogging force.

FIG. 1 is a graph showing a cogging force according to the displacement of the rotor of the linear generator, and an average of the cogging force.

Referring to FIG. 1, although the average of the cogging force is about 1000 N and the external force is 1100 N, since the external force cannot always overcome the cogging force, the movement of the rotor is restricted. In particular, since the linear generator performs reciprocating motion, the inertia of the rotor becomes zero at a time point of changing the direction of the movement of the rotor. Accordingly, when the external force larger than the cogging force is not exerted, the linear generator cannot move.

FIG. 2 is a cross-sectional view showing a structure of a conventional linear generator. FIG. 3 is a diagram showing magnetic flux lines acting on the linear generator of FIG. 2. FIG. 4 is a graph showing a cogging force exerted per slot of the linear generator of FIG. 2.

Referring to FIG. 2, a stator 30 in which magnets 32 of N poles and S poles are arranged alternately on a back born 31 is located at the bottom. Further, a core 21 is located above the stator 30, and coils 25 made of enameled wires are inserted into teeth 22 of the core 21, respectively. A portion consisting of the core 21 and the coils 25 becomes a core assembly 20. That is, a linear generator 10 consists of the core assembly 20 and the stator 30.

Referring to FIG. 3, the core 21 is formed of a material into which a magnetic force is induced, and the magnetic force formed from the N poles of the magnets 32 reaches the S poles through the core 21.

When the stator 30 and the core assembly 20 perform reciprocating motion laterally while maintaining a predetermined interval, the magnetic flux density induced in each of the teeth 22 is changed. When the magnetic flux density induced in each of the teeth 22 is changed according to the time, an electromotive force occurs due to a change of the entire magnetic flux passing through the cross-sectional area of the coils 25, and the current flows in the coils 25. If a ratio of the pole pitch to the slot pitch is 1:1, a phase difference of the electromotive forces at the ends of the coils 25 facing each other is 180 degrees. Accordingly, if the adjacent coils 25 are connected in opposite directions, there is an effect of serial connection of electromotive forces of the same phase.

The cogging force exerted per slot can be represented by Fourier series expansion, and expressed by the following Eq. 1:

$${f}_{i} = {\sum }_{n = 1}^{∞} {A}_{n} sin ( n w x + {α}_{n} ) , \\ w = \frac{2 π}{{τ}_{p}} \qquad Eq . 1$$

where Aₙ and αₙ are a force exerted on the n-th slot and a phase harmonic component, respectively. This force is in the approximate form of a trigonometric function, and the force is divided into stable and unstable points according to the location, and tends to be attracted toward the stable point. This feature is shown in FIG. 4.

If a ratio of the pole pitch to the slot pitch is 1:1, the cogging force increases in proportion to the number of slots. Accordingly, as the number of slots increases in order to obtain a larger power, a larger cogging force is generated. If the number of slots is ten, the cogging force exerted on the core assembly 20 also becomes ten times.

Thus, the study of the linear generator has been conducted to decrease the cogging force while increasing the magnetic flux. There is a method of varying a ratio of the slot pitch to the pole pitch in order to attenuate the cogging force. According to the recent study trend, it is known that it is possible to reduce the cogging force due to a phase difference in the case of 9 poles and 10 slots to satisfy 9τp=10τs (τp: pole pitch, τs: slot pitch).

The sum of cogging forces exerted on the core assembly 20 consisting of ten teeth 22 is expressed by the following Eq. 2:

$$\begin{matrix}{F}_{9 p 10 s} ( x ) = {\sum }_{i = 1}^{10} {\sum }_{n = 1}^{∞} {A}_{n} sin ( n w x + {α}_{n} + \frac{π}{10} i ) \\ = 10 {\sum }_{m = 1}^{∞} {A}_{10 m} sin ( 10 m w x + {α}_{10 m} )\end{matrix} \qquad Eq . 2$$

In this case, only harmonic components corresponding to multiples of 10 are left, and remaining harmonic components corresponding to multiples of 1 to 9 are offset by a phase difference, thereby significantly reducing the cogging force. However, there still occurs a problem that there is a phase difference of 36 degrees between adjacent slots. However, it is possible to produce a three-phase AC power by properly arranging the order in which the coils are connected, but it is impossible to completely reduce the cogging force even if the phase difference is used.

Further, it is possible to offset the cogging force by setting the phase difference to 180 degrees. However, since the cogging force itself does not form perfect bilateral symmetry, perfect offset is difficult. Since the volume occupied by the magnets in the rotor is small, the space efficiency is reduced. There is inconvenience in the assembly that a separate adhesive should be used in order to attach the magnets.

### PRIOR ART DOCUMENT

[Patent Document] Korean Patent Laid-open Publication No. 10-2011-0082183 (published on Jul. 18, 2011)

### SUMMARY

The present invention provides a linear generator having a structure of N poles and N+1 slots and offering an excellent effect of attenuating a cogging force, and a method for generating power using the same.

The present invention also provides a linear generator using a flux concentration method capable of configuring a rotor even without using an adhesive while increasing space efficiency of magnets of a rotor, and a method for generating power using the same.

The objects of the present invention are not limited thereto, and the other objects of the present invention will be described in or be apparent from the following description of the embodiments.

According to an aspect of the present invention, there is provided a linear generator comprising: a magnet module including magnets located between a plurality of flux concentration blocks, the magnets located on both sides of each of the flux concentration blocks being arranged such that the magnets having the same pole face each other, and a magnetic flux generated from the magnets is induced into both ends of each of the flux concentration blocks; and core modules including coils and located on both sides of the magnet module to generate induced electromotive forces in the coils by the magnetic flux as the core modules move.

According to another aspect of the present invention, there is provided a linear generator comprising: a magnet module including magnets located between a plurality of flux concentration blocks, and core modules located on both sides of the magnet module to generate induced electromotive forces in coils wound on a plurality of teeth extending from cores as the core modules move, wherein a relationship between a pole pitch that is a unit value obtained by adding a width of the magnets to a width of the flux concentration blocks and a slot pitch that is a unit value obtained by adding a width of the teeth to a distance between the teeth is a structure of N poles and N+1 slots in which N×pole pitch is equal to (N+1)×slot pitch.

According to another aspect of the present invention, there is provided a method for generating power using a linear generator including a magnet module in which magnets are located between a plurality of flux concentration blocks and core modules located on both sides of the magnet module, the method comprising: arranging the magnets located between the flux concentration blocks such that the magnets having the same pole face each other across each of the flux concentration blocks to induce a magnetic flux generated from the magnets into both ends of each of the flux concentration blocks; connecting the core modules to LM blocks to move along LM rails; generating induced electromotive forces in coils included in the core modules according to movement of the core modules; allowing rectifier circuits respectively connected to the coils to rectify currents flowing in the coils due to the induced electromotive forces; and calculating a sum of the rectified currents by a serial connection of the coils and outputting the sum.

The other aspects of the present invention are included in the detailed description and drawings.

### BRIEF DESCRIPTION OF THE DRAWINGS

The above and other aspects and features of the present invention will become more apparent by describing in detail exemplary embodiments thereof with reference to the attached drawings, in which:

FIG. 1 is a graph showing a cogging force according to the displacement of the rotor of the linear generator, and an average of the cogging force;

FIG. 2 is a cross-sectional view showing a structure of a conventional linear generator;

FIG. 3 is a diagram showing magnetic flux lines acting on the linear generator of FIG. 2;

FIG. 4 is a graph showing a cogging force exerted per slot of the linear generator of FIG. 2;

FIG. 5 is a perspective view of a linear generator in accordance with an embodiment of the present invention;

FIG. 6 is a cross-sectional view of a magnet module used in the linear generator of FIG. 5;

FIG. 7 is a perspective view of the magnet module used in the linear generator of FIG. 5;

FIG. 8 is a perspective view of a linear motion (LM) rail connected to the magnet module used in the linear generator of FIG. 5;

FIG. 9 is a top view of the linear generator of FIG. 5;

FIG. 10 is a diagram showing rectifier circuits connected to the coils used in the linear generator in accordance with the embodiment of the present invention.

FIG. 11A is a graph showing the power outputted from the coils wound on ten slots of the linear generator in accordance with the embodiment of the present invention;

FIG. 11B is a graph showing the rectified power obtained by rectifying the power outputted from the coils wound on ten slots of the linear generator in accordance with the embodiment of the present invention;

FIG. 11C is a graph showing the rectified power outputted by serial connection of the coils wound on ten slots of the linear generator in accordance with the embodiment of the present invention; and

FIG. 12 is a flowchart of a method for generating power using the linear generator in accordance with the embodiment of the present invention.

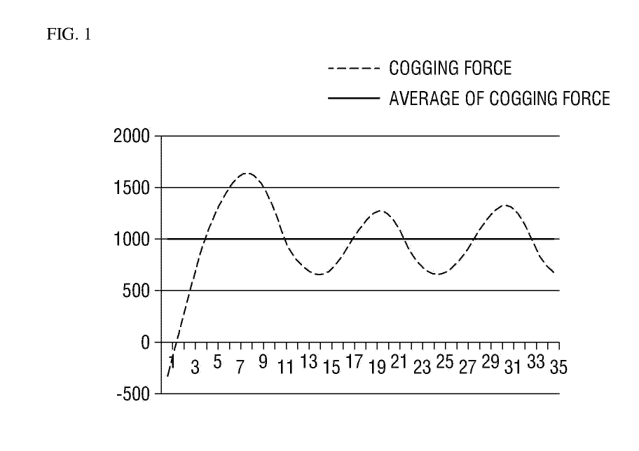

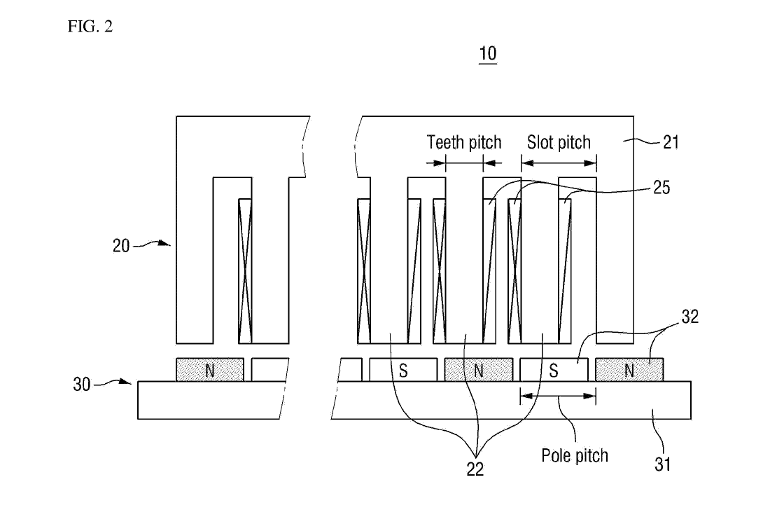

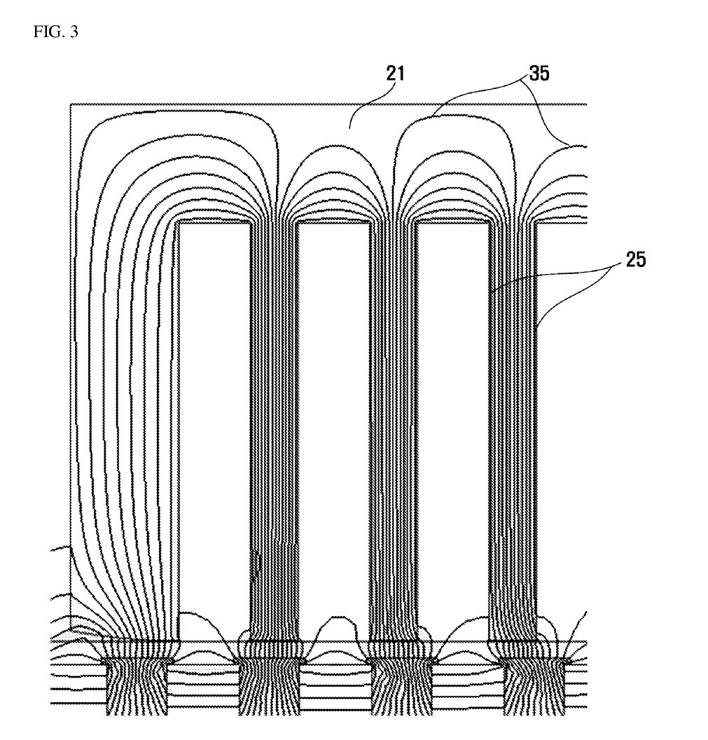

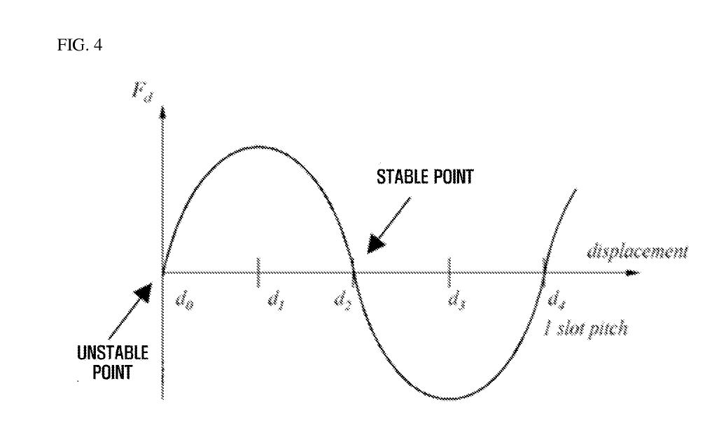

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, the present invention will be described in detail with reference to the accompanying drawings.

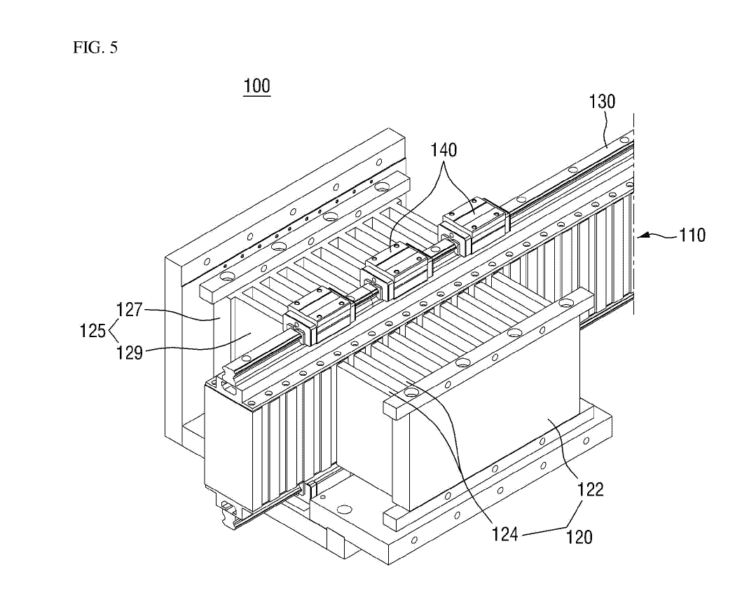

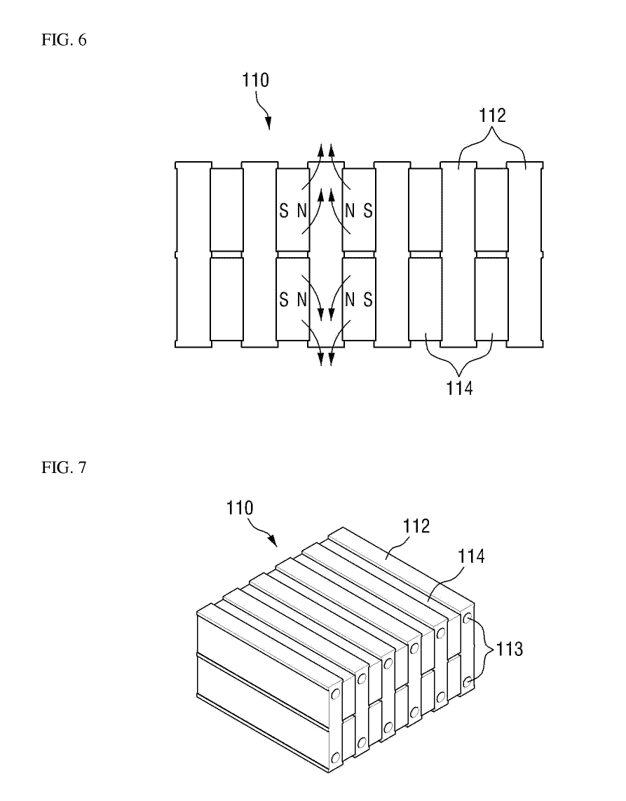

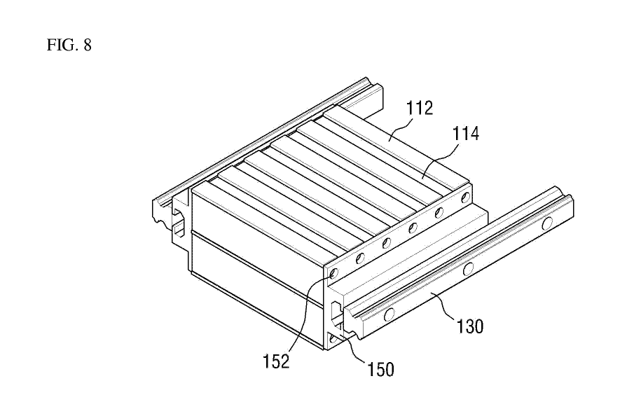

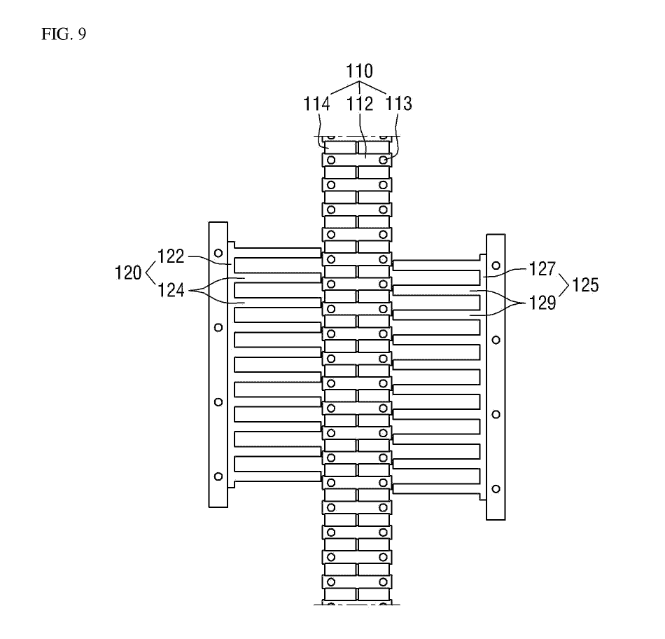

FIG. 5 is a perspective view of a linear generator in accordance with an embodiment of the present invention. FIG. 6 is a cross-sectional view of a magnet module used in the linear generator of FIG. 5. FIG. 7 is a perspective view of the magnet module used in the linear generator of FIG. 5. FIG. 8 is a perspective view of a linear motion (LM) rail connected to the magnet module used in the linear generator of FIG. 5. FIG. 9 is a top view of the linear generator of FIG. 5.

Referring to FIGS. 5 to 9, a linear generator 100 in accordance with an embodiment of the present invention includes a magnet module 110, a core module 120, LM rails 130, LM blocks 140, rail fixing plates 150 and the like.

The magnet module 110 is configured such that magnets 114 are located between flux concentration blocks 112. The magnets 114 located on both sides of each of the flux concentration blocks 112 are arranged such that the magnets having the same pole face each other, and the flux generated from the magnets 114 is induced into both ends of each of the flux concentration blocks 112. In this case, the flux concentration blocks 112 are formed of iron. Further, neodymium magnets can be mainly used as the magnets.

As shown in FIG. 6, the magnets 114 are arranged such that the magnets having the same pole face each other across each of the flux concentration blocks 112. Accordingly, the direction of the magnetic flux is a horizontal direction in the vicinity of the magnets 114, and becomes a vertical direction while approaching the center of the flux concentration blocks 112. This method is called a flux concentration method.

Further, at least one of the magnets 114 is located between the flux concentration blocks 112. The two magnets 114 are located between the flux concentration blocks 112 in FIG. 6, but it will be apparent to those skilled in the art that the present invention is not limited thereto.

Since the magnetic flux density is the nature of a material, there is a limit to the magnetic flux density that can be obtained by using only the magnets 114. However, when using the flux concentration method, as a ratio of the vertical cross-sectional area of the flux concentration blocks 112 to the cross-sectional area of the magnets 114 is larger, the larger magnetic flux can be induced. Thus, it is possible to induce a magnetic flux which is two to three times more powerful than the used magnets 114.

When using this flux concentration method, assembly can be easily performed while increasing the strength of the magnets 114. Since the flux concentration blocks 112 are generally formed of iron, the magnets 114 are attached to the flux concentration blocks 112. Although the magnets 114 are attached to one surface of each of the flux concentration blocks 112, the magnets 114 having the same pole can be attached to the other surface thereof. A repulsive force is exerted between the magnets 114, but an attractive force is exerted between the magnets 114 due to the presence of the flux concentration blocks 112 between the magnets 114, thereby stably maintaining the structure of the magnet module 110.

Further, a plurality of protrusions for preventing the separation of the magnets 114 located between the flux concentration blocks 112 are formed in the flux concentration blocks 112. That is, in order to prevent the separation of the magnets 114, protrusions are disposed at both vertical ends of the flux concentration blocks 112, and the magnets 114 are restricted by the protrusions, thereby preventing the separation of the magnets 114 in the vertical direction. Accordingly, when restricting the magnets 114 only in the horizontal direction, it is possible to completely fix the magnets 114.

The core module 120 includes coils 160, and the core modules are located on both sides of the magnet module 110. As they move, an induced electromotive force is generated in each of the coils 160 by the magnetic flux. To this end, the core module 120 may include cores 122 and a plurality of teeth 124 extending from the cores 122 and on which the coils 160 are wound.

In this case, laminated silicon steel may be used as the cores 122. The laminated silicon steel is made of a material in which a magnetic force is induced, and the magnetic force formed from the N poles of the magnets 114 reaches the S poles of the magnets 114 through the cores 122.

Further, the number of the teeth 124 in the core module 120 may be changed appropriately by a designer. If the core module 120 moves with respect to the magnet module 110 (or the core module 120 is fixed and the magnet module 110 moves on the contrary), the linear generator 100 has a structure of N poles and N+1 slots according to the number of the teeth 124. At this time, preferably, it is designed such that N×pole pitch is equal to (N+1)×slot pitch. That is, Nτp=(N+1)τs (τp: pole pitch, τs: slot pitch) is preferable. In this case, the pole pitch (τp) is a unit value obtained by adding the width of the magnets 114 to the width of the flux concentration blocks 112, and the slot pitch (τs) means a unit value obtained by adding the width of the teeth 124 to the distance between the teeth 124.

Further, FIG. 9 shows a bilateral structure in which two core modules 120 and 125 are located on both sides of the magnet module 110. Accordingly, since two core modules 120 and 125 have a phase difference of 180 degrees, a cogging force also has a phase difference of 180 degrees.

The LM rails 130 are installed on both ends of the magnet module 110. The LM blocks 140 are connected to the core module 120 and move along the LM rails 130 to move the core module 120.

Further, the rail fixing plates 150 are fastened to both ends of the magnet module 110 such that the LM rails 130 are installed on both ends of the magnet module. To this end, as shown in FIG. 7, the flux concentration blocks 112 include fastening holes 113 on both ends, and the rail fixing plates 150 and the flux concentration blocks 112 are fastened to each other by fastening members (not shown). The rail fixing plates 150 serve to connect the LM rails 130 to the magnet module 110, and also serve to fix the flux concentration blocks 112. In this case, since the rail fixing plates 150 should not be induced by the magnetic flux, it is preferable that the rail fixing plates 150 are formed of aluminum. Further, the rail fixing plates 150 are fastened to the flux concentration blocks 112 by fastening members, and include fastening holes 152 for this purpose.

Referring to FIG. 5, the rail fixing plates 150 are connected to the top of the magnet module 110, and the LM rails 130 are connected to the rail fixing plates 150. Further, the LM blocks 140 move on the LM rails 130, and the core module 120 moves according to the movement of the LM blocks 140. As the core module 120 moves, an induced electromotive force is generated in each of the coils 160 of the core module 120. In this case, the magnet module 110 serves as a stator, and the core module 120 serves as a rotor. However, on the contrary, the magnet module 110 may serve as a rotor, and the core module 120 may serve as a stator.

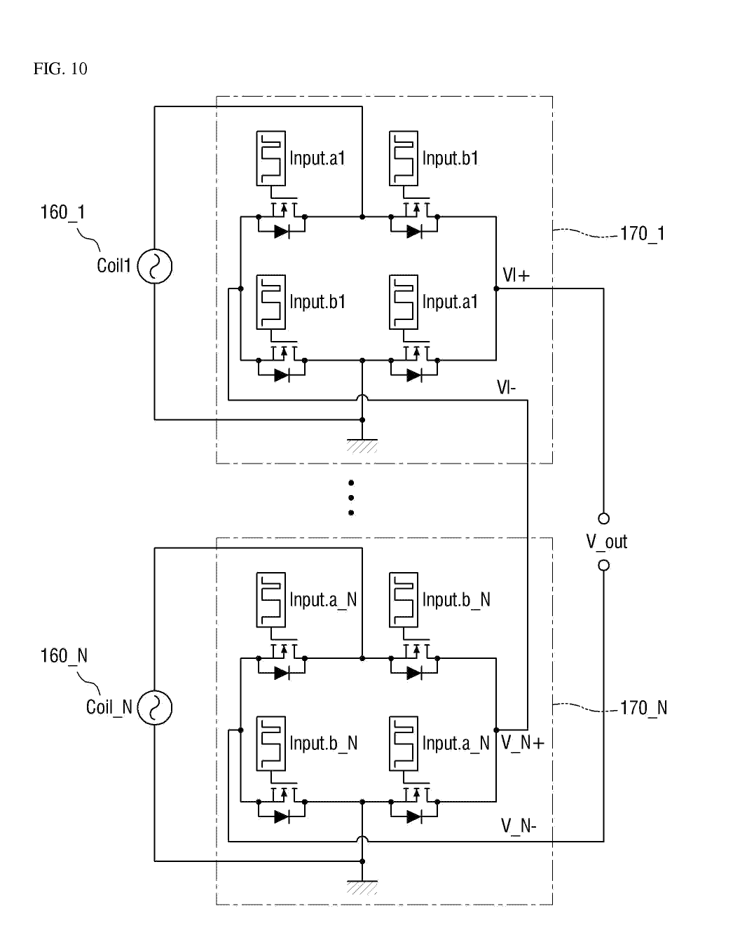

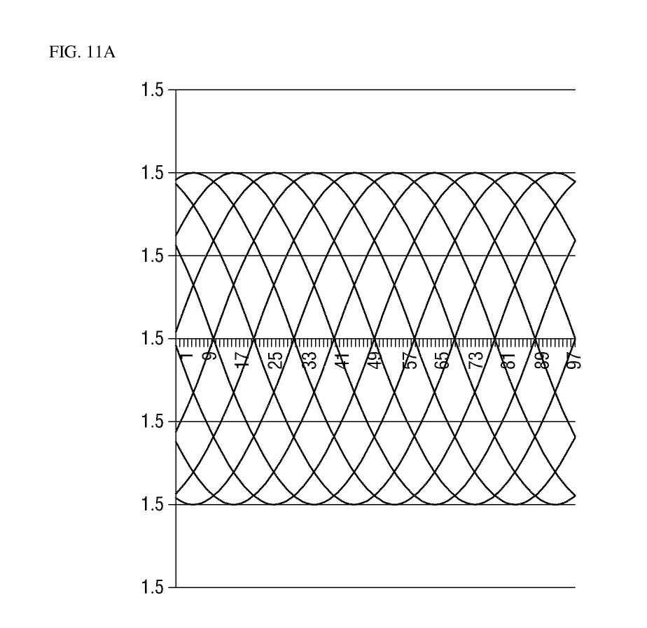

FIG. 10 is a diagram showing circuits connected to the coils used in the linear generator in accordance with the embodiment of the present invention.

As described above, the power generated by the interaction of the magnet module 110 and the core module 120 is alternating power. If the power is varied periodically, a damping coefficient of the generator itself is changed, thereby interfering with the smooth reciprocating motion of the rotor. This non-uniform counter electromotive force and cogging force interfere with an external thrust force to make the generator motionless, or cause the non-uniform movement of the generator.

In order to solve this problem, it is necessary to convert alternating current into direct current. Accordingly, the core module 120 may include a plurality of rectifier circuits 170 connected to the coils 160 wound on the teeth 124, respectively. Further, it is preferable that the coils 160 are connected in series. In this case, the rectifier circuits 170 may be full-bridge rectifier circuits, and it is preferable that each of the rectifier circuits 170 consists of four MOSFETs.

In the linear generator 100 having a structure of N poles and N+1 slots in which N×pole pitch is equal to (N+1)×slot pitch, a phase difference is generated in the power generated from the coils 160, and a phase difference of 360/(n+1) degrees is formed between adjacent slots. However, if the electromotive forces generated in the respective slots are combined simply in parallel or in series, the electromotive force becomes zero by the repetition of the same phase difference. Accordingly, after rectifying the electromotive forces generated in the respective slots, the electromotive forces are connected in series.

Referring to FIG. 10, since the current flowing from each of the coils 160 is close to alternating current, it can be represented by notation of alternating current. The power generated from Coil 1(160_1) to Coil_N(160_N) passes through the rectifier circuits 170. Each of the rectifier circuits 170 consists of four MOSFETs. The switch input for driving each MOSFET is determined by the direction of the voltage across the coil 160. If the voltage across the coil is positive (+) (based on the ground), a signal of 1 is applied to input.b through a comparator, and a signal of 0 is applied to input.a. Since the current flows into only the MOSFET to which a signal of 1 is applied, the current generated from Coil 1(160_1) flows outward through V1+ and flows inward through V1−. On the other hand, if the voltage across the coil is negative (−), a signal of 1 is applied to input.a, and a signal of 0 is applied to input.b. Eventually, the current induced from Coil 1(160_1) flows through V1+. In this way, when the rectifier circuits 170 are provided in the N coils 160, and all outputs from V1+ to V_N+ of the respective circuits are connected in series, all of electromotive forces are combined in the positive direction, thereby obtaining a direct current (DC) power.

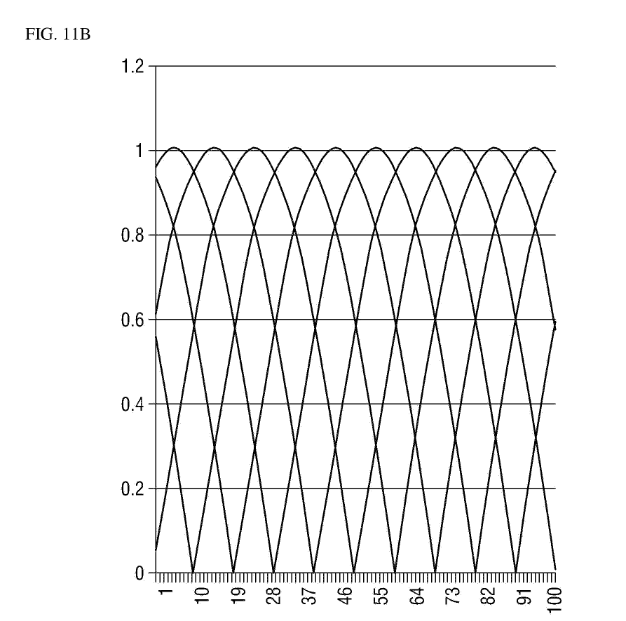

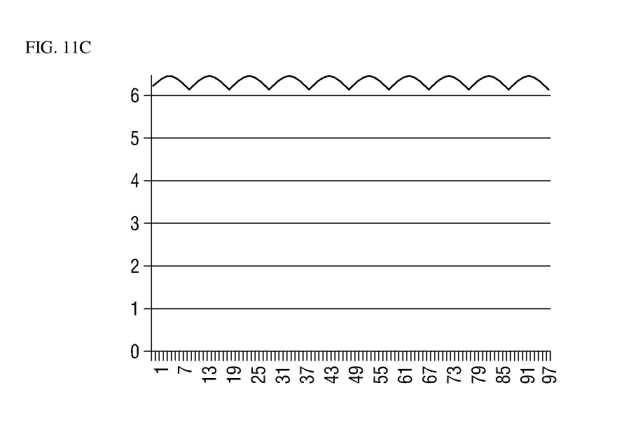

FIG. 11A is a graph showing the power outputted from the coils wound on ten slots of the linear generator in accordance with the embodiment of the present invention. FIG. 11B is a graph showing the rectified power obtained by rectifying the power outputted from the coils wound on ten slots of the linear generator in accordance with the embodiment of the present invention. FIG. 11C is a graph showing the rectified power outputted by serial connection of the coils wound on ten slots of the linear generator in accordance with the embodiment of the present invention.

As described above, a phase difference occurs in the electromotive forces generated from the respective slots of the core module 120. Accordingly, if the electromotive forces generated in the respective slots are combined simply in parallel or in series, the electromotive force becomes zero by the repetition of the same phase difference.

In FIGS. 11A to 11C, a structure of 9 poles and 10 slots is supposed for explanation of a DC induction process.

In FIG. 11A, each of the coils 160 has a phase difference of 36 degrees (360 degrees/10 slots) from the adjacent coil. The electromotive force induced from each of the coils 160 has a sine wave form under the assumption that it has the same maximum value.

In FIG. 11B, the power coming from each slot is induced only in the positive (+) direction through the rectifier circuit 170, thereby generating only the positive power from each of the coils 160.

In FIG. 11C, when connecting the coils 160 in series, it is possible to obtain the effective power that is the sum of the positive (+) powers generated from the slots. In this case, as the number of slots increases, it is possible to obtain the ripple-free DC power.

Accordingly, it is possible to achieve the linear generator 100 having a structure of N poles and N+1 slots by extending the existing structure of 9 poles and 10 slots. Further, it is possible to obtain a DC output by configuring switch circuits (rectifier circuits). In this configuration, since the number of slots is not limited, the number of slots may increase or decrease according to the need, and the degree of freedom in the design of the linear generator increases. In addition, since the output is a DC output, the uniform counter electromotive force can be induced and the smooth movement of the generator can be achieved.

That is, it is possible to ensure the motility at any external force by lowering the threshold external force for driving the generator. Thus, an effective response is possible even in the non-uniform and irregular wave energy.

The linear generator in accordance with another embodiment of the present invention includes the magnet module in which the magnets are located between the flux concentration blocks and the core modules which are located on both sides of the magnet module to generate induced electromotive forces in the coils wound on a plurality of teeth extending from the cores as they move. A relationship between the pole pitch that is a unit value obtained by adding the width of the magnets to the width of the flux concentration blocks, and the slot pitch that is a unit value obtained by adding the width of the teeth to the distance between the teeth is characterized in a structure of N poles and N+1 slots in which N×pole pitch is equal to (N+1)×slot pitch.

In the magnet module, the magnets are arranged such that the magnets having the same pole face each other, and the magnetic flux generated from the magnets is induced into both ends of each of the flux concentration blocks. Accordingly, the direction of the magnetic flux in the magnet module is bent by 90 degrees as it approaches the center of the flux concentration blocks.

Further, in the core module, the rectifier circuits are connected to the coils wound on a plurality of teeth, respectively. In this case, the coils are connected in series. The rectifier circuits may be formed of full-bridge rectifier circuits, and it is preferable that each of the rectifier circuits consists of four MOSFETs.

Since a detailed configuration of the magnet module and the core module of the linear generator in accordance with another embodiment of the present invention is similar to that described above, a repeated description will be omitted.

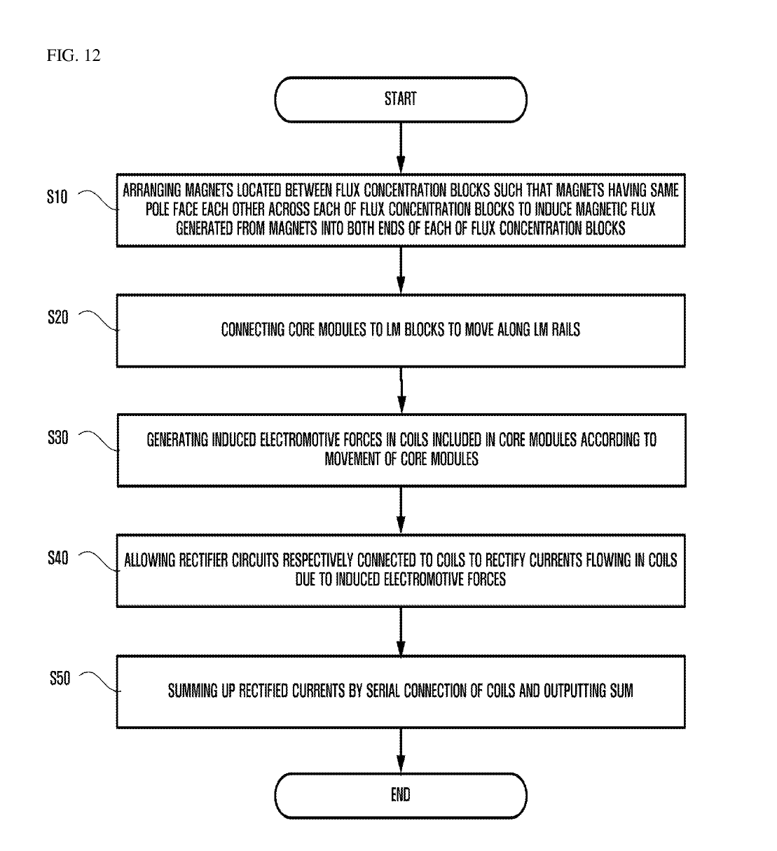

FIG. 12 is a flowchart of a method for generating power using the linear generator in accordance with the embodiment of the present invention.

As the method for generating power using the linear generator in accordance with the embodiment of the present invention, in a method for generating power using the linear generator 100 including the magnet module 110 in which the magnets 114 are located between the flux concentration blocks 112 and the core modules 120 located on both sides of the magnet module 110, by arranging the magnets 114 located between the flux concentration blocks 112 such that the magnets having the same pole face each other across each of the flux concentration blocks 112, the magnetic flux generated from the magnets 114 is induced into both ends of each of the flux concentration blocks 112 (S 10). The core module 120 is connected to the LM blocks 140 to move along the LM rails 130 (S20), and an induced electromotive force is generated in each of the coils 160 included in the core module 120 according to the movement of the core module 120 (S30). The currents flowing in the coils 160 by the generated induced electromotive forces are rectified by the rectifier circuits 170 connected to the coils 160, respectively (S40). The rectified currents are summed up by a serial connection of the coils 160 and outputted (S50).

By this method for generating power, it is possible to achieve an effect of offsetting the cogging force, which is theoretically close to zero, by using a bilateral structure (the rotor is placed symmetrically with respect to the stator).

According to the present invention, magnets can be implemented in a linear generator even without using an adhesive while increasing space efficiency of magnets used in the linear generator by using a flux concentration method.

Further, it is possible to increase an effect of attenuating a cogging force by extending a structure of 9 poles and 10 slots, which is a conventional structure of a linear generator, to a structure of N poles and N+1 slots.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A linear generator comprising:
a magnet module including magnets located between a plurality of flux concentration blocks, the magnets located on both sides of each of the flux concentration blocks being arranged such that the magnets having the same pole face each other, and a magnetic flux generated from the magnets is induced into both ends of each of the flux concentration blocks; and
core modules including coils and located on both sides of the magnet module to generate induced electromotive forces in the coils by the magnetic flux as the core modules move.

2. The linear generator of claim 1, wherein the flux concentration blocks of the magnet module are formed of iron.

3. The linear generator of claim 1, wherein in the magnet module, a plurality of protrusions for preventing separation of the magnets located between the flux concentration blocks are formed in the flux concentration blocks.

4. The linear generator of claim 1, wherein in the magnet module, at least one magnet is located between the flux concentration blocks.

5. The linear generator of claim 1, wherein each of the core modules includes cores and a plurality of teeth extending from the cores and on which the coils are wound.

6. The linear generator of claim 5, wherein the linear generator has a structure of N poles and N+1 slots in which N×pole pitch is equal to (N+1)×slot pitch, and
wherein the pole pitch is a unit value obtained by adding a width of the magnets to a width of the flux concentration blocks, and the slot pitch is a unit value obtained by adding a width of the teeth to a distance between the teeth.

7. The linear generator of claim 5, wherein each of the core modules further includes a plurality of rectifier circuits respectively connected to the coils wound on the teeth.

8. The linear generator of claim 7, wherein in each of the core modules, the coils are connected in series.

9. The linear generator of claim 1, further comprising:
linear motion (LM) rails installed on both ends of the magnet module; and
LM blocks which are connected to the core modules and move along the LM rails to move the core modules.

10. The linear generator of claim 9, further comprising rail fixing plates to install the LM rails on both ends of the magnet module.

11. The linear generator of claim 10, wherein the rail fixing plates are formed of aluminum.

12. The linear generator of claim 10, wherein the flux concentration blocks include fastening holes on both ends, and the rail fixing plates and the flux concentration blocks are fastened to each other by fastening members.

13. A linear generator comprising:
a magnet module including magnets located between a plurality of flux concentration blocks, and
core modules located on both sides of the magnet module to generate induced electromotive forces in coils wound on a plurality of teeth extending from cores as the core modules move,
wherein a relationship between a pole pitch that is a unit value obtained by adding a width of the magnets to a width of the flux concentration blocks and a slot pitch that is a unit value obtained by adding a width of the teeth to a distance between the teeth is a structure of N poles and N+1 slots in which N×pole pitch is equal to (N+1)×slot pitch.

14. The linear generator of claim 13, wherein in the magnet module, the magnets are arranged on both sides of each of the flux concentration blocks such that the magnets having the same pole face each other across each of the flux concentration blocks, and a magnetic flux generated from the magnets is induced into both ends of each of the flux concentration blocks.

15. The linear generator of claim 14, wherein in the magnet module, a direction of the magnetic flux is bent by 90 degrees as it approaches a center of each of the flux concentration blocks.

16. The linear generator of claim 13, wherein in the core modules, rectifier circuits are respectively connected to the coils wound on the teeth.

17. The linear generator of claim 16, wherein the rectifier circuits are full-bridge rectifier circuits.

18. The linear generator of claim 17, wherein each of the rectifier circuits consists of four MOSFETs.

19. The linear generator of claim 17, wherein in each of the core modules, the coils are connected in series.

20. A method for generating power using a linear generator including a magnet module in which magnets are located between a plurality of flux concentration blocks and core modules located on both sides of the magnet module, the method comprising:
arranging the magnets located between the flux concentration blocks such that the magnets having the same pole face each other across each of the flux concentration blocks to induce a magnetic flux generated from the magnets into both ends of each of the flux concentration blocks;
connecting the core modules to LM blocks to move along LM rails;
generating induced electromotive forces in coils included in the core modules according to movement of the core modules;
allowing rectifier circuits respectively connected to the coils to rectify currents flowing in the coils due to the induced electromotive forces; and
calculating a sum of the rectified currents by a serial connection of the coils and outputting the sum.
